(19) United States
(12) Patent Application Publication
(10) Pub. No.: US 2020/0236361 A1
(43) Pub. Date: Jul. 23, 2020

(54) INTRA PREDICTION MODE BASED IMAGE PROCESSING METHOD, AND APPARATUS THEREFOR

(71) Applicant: LG ELECTRONICS INC., Seoul (KR)

(72) Inventors: Hyeongmoon JANG, Seoul (KR); Seunghwan KIM, Seoul (KR); Jaehyun LIM, Seoul (KR)

(21) Appl. No.: 16/632,211

(22) PCT Filed: Jul. 18, 2018
(86) PCT No.: PCT/KR2018/008128

§ 371 Date: Jan. 17, 2020

Related U.S. Application Data
(60) Provisional application No. 62/533,693, filed on Jul. 18, 2017.

(51) Int. Cl. H04N 19/132; H04N 19/105; H04N 19/117; H04N 19/159; H04N 19/46; H04N 19/176

(52) U.S. Cl. CPC H04N 19/132; H04N 19/105; H04N 19/176; H04N 19/159; H04N 19/46; H04N 19/117

(57) ABSTRACT

Disclosed herein are an intra prediction mode based image processing method and an apparatus therefor. Specifically, a method for processing an image based on an intra prediction mode may include: generating a first prediction sample and a second prediction sample using a reference sample adjacent to a current block; generating a final prediction sample of the current block by performing a weighted addition of the first and second prediction samples; and reconstructing the current block by adding the final prediction sample to a residual sample of the current block.

### CROSS-REFERENCE TO RELATED APPLICATIONS

This application is the National Stage filing under 35 U.S.C. 371 of International Application No. PCT/KR2018/008128, filed on Jul. 18, 2018, which claims the benefit of U.S. Provisional Applications No. 62/533,693, filed on Jul. 18, 2017, the contents of which are all hereby incorporated by reference herein in their entirety.

### TECHNICAL FIELD

The disclosure relates to a still image or moving image processing method and, more particularly, to a method of encoding/decoding a still image or moving image based on an intra prediction mode and an apparatus supporting the same.

### BACKGROUND ART

A compression encoding means a series of signal processing techniques for transmitting digitized information through a communication line or techniques for storing the information in a form that is proper for a storage medium. The media including a picture, an image, an audio, and the like may be the target for the compression encoding, and particularly, the technique of performing the compression encoding targeted to the picture is referred to as a video image compression.

The next generation video contents are supposed to have the characteristics of high spatial resolution, high frame rate and high dimensionality of scene representation. In order to process such contents, drastic increase of memory storage, memory access rate and processing power will be resulted.

Accordingly, it is required to design the coding tool for processing the next generation video contents efficiently.

### DISCLOSURE

### Technical Problem

An embodiment of the present disclosure provides a weight-based intra prediction method of generating a prediction block by applying a weight to a reference sample or a prediction sample.

Furthermore, an embodiment of the present disclosure provides a method for performing intra prediction using a generalized weight regardless of an intra prediction mode.

The technical objects of the present disclosure are not limited to the aforementioned technical objects, and other technical objects, which are not mentioned above, will be apparently appreciated by a person having ordinary skill in the art from the following description.

### Technical Solution

In an aspect of the present disclosure, provided is a method for processing an image based on an intra prediction mode which may include: generating a first prediction sample and a second prediction sample using a reference sample adjacent to a current block; generating a final prediction sample of the current block by performing a weighted addition of the first and second prediction samples; and reconstructing the current block by adding the final prediction sample to a residual sample of the current block.

Preferably, the generating of the first and second prediction samples may include filtering the reference sample adjacent to the current block and the first prediction sample may be generated by using a reference sample determined according to a prediction direction of a prediction mode of the current block among reference samples which are not filtered and the second prediction sample may be generated by using a reference sample determined according to the prediction direction of the prediction mode of the current block among filtered reference samples.

Preferably, the generating of the first and second prediction samples may include deriving a bottom right reference sample adjacent to a lower right side of the current block, and deriving lower and right reference samples of the current block using a left reference sample, an upper reference sample, and the bottom right reference sample of the current block, and the first prediction sample may be generated by using a reference sample determined according to the prediction direction of the prediction mode of the current block among the left or upper reference samples, and the second prediction sample may be generated by using a reference sample determined according to the prediction direction of the prediction mode of the current block among the lower or right reference samples.

Preferably, when the prediction mode of the current block belongs to a predetermined specific prediction mode, a weight intra prediction of generating a prediction sample using reference samples in which a weight is applied to the current block may be applied.

Preferably, weights applied to the first prediction sample and the second prediction sample, respectively may be determined by using a predetermined weight table.

Preferably, the weight table may be generated based on a distance from a reference pixel determined according a prediction direction of a specific prediction mode.

Preferably, a flag indicating whether to apply a weight intra prediction of generating the prediction sample using reference samples in which weights are applied to the current block may be transmitted from an encoder.

In another aspect of the present disclosure, provided is an apparatus for processing an image based on an intra prediction mode, which may include: a temporary prediction sample generation unit generating a first prediction sample and a second prediction sample using a reference sample adjacent to a current block; a final prediction sample generation unit generating a final prediction sample of the current block by performing a weighted addition of the first and second prediction samples; and a reconstruction unit reconstructing the current block by adding the final prediction sample to a residual sample of the current block.

Preferably, the temporary prediction sample generation unit may filter the reference sample adjacent to the current block, and the first prediction sample may be generated by using a reference sample determined according to the prediction direction of the prediction mode of the current block among reference samples which are not filtered, and the second prediction sample may be generated by using a reference sample determined according to the prediction direction of the prediction mode of the current block among filtered reference samples.

Preferably, the temporary prediction sample generation unit may derive a bottom right reference sample adjacent to a lower right side of the current block and derives lower and right reference samples of the current block using a left reference sample, an upper reference sample, and the bottom right reference sample of the current block, and the first prediction sample may be generated by using a reference sample determined according to the prediction direction of the prediction mode of the current block among the left or upper reference samples, and the second prediction sample may be generated by using a reference sample determined according to the prediction direction of the prediction mode of the current block among the lower or right reference samples.

Preferably, when the prediction mode of the current block belongs to a predetermined specific prediction mode, a weight intra prediction of generating a prediction sample using reference samples in which a weight is applied to the current block may be applied.

Preferably, weights applied to the first prediction sample and the second prediction sample, respectively may be determined by using a predetermined weight table.

Preferably, the weight table may be generated based on a distance from a reference pixel determined according a prediction direction of a specific prediction mode.

Preferably, a flag indicating whether to apply a weight intra prediction of generating the prediction sample using reference samples in which weights are applied to the current block may be transmitted from an encoder.

### ADVANTAGEOUS EFFECTS

According to an embodiment of the present disclosure, intra prediction is performed using reference samples to which a weight is applied, thereby increasing accuracy of prediction.

Further, according to an embodiment of the present disclosure, the intra prediction is performed using a generalized weight table to improve a memory problem depending on use of a parameter trained for each prediction mode and enhance compression performance.

Effects obtainable in the present disclosure are not limited to the aforementioned effects and other unmentioned effects will be clearly understood by those skilled in the art from the following description.

### DESCRIPTION OF DRAWINGS

The accompanying drawings, which are included herein as a part of the description for help understanding the disclosure, provide embodiments of the disclosure, and describe the technical features of the disclosure with the description below.

FIG. 1 is an embodiment to which the disclosure is applied, and shows a schematic block diagram of an encoder in which the encoding of a still image or moving image signal is performed.

FIG. 2 is an embodiment to which the disclosure is applied, and shows a schematic block diagram of a decoder in which the encoding of a still image or moving image signal is performed.

FIG. 3 is a diagram for illustrating the split structure of a coding unit to which the disclosure may be applied.

FIG. 4 is a diagram for illustrating a prediction unit to which the disclosure may be applied.

FIG. 5 is an embodiment to which the disclosure is applied and is a diagram illustrating an intra prediction method.

FIG. 6 illustrates prediction directions according to intra prediction modes.

FIGS. 7 and 8 are diagrams for describing a linear interpolation prediction method as an embodiment to which the present disclosure is applied.

FIG. 9 is a diagram for describing a position-dependent intra prediction combination method as an embodiment to which the present disclosure may be applied.

FIG. 10 is a flowchart showing a method for determining whether to apply weight intra prediction based on an intra prediction mode as an embodiment to which the present disclosure is applied.

FIGS. 11 to 13 are diagrams illustrating a generalized weight table used for weight-based intra prediction according to an embodiment of the present disclosure.

FIG. 14 is a diagram illustrating a method for generating a weight-based intra prediction sample according to an embodiment of the present disclosure.

FIG. 15 is a diagram illustrating a method for generating a weight-based intra prediction sample according to an embodiment of the present disclosure.

FIG. 16 is a flowchart showing a method for determining whether to apply weight intra prediction based on an intra prediction mode as an embodiment to which the present disclosure is applied.

FIG. 17 is a diagram illustrating a method for generating a weight-based intra prediction sample as an embodiment to which the present disclosure is applied.

FIG. 18 is a diagram illustrating a method for generating a weight-based intra prediction sample as an embodiment to which the present disclosure is applied.

FIG. 19 is a diagram illustrating a method for generating a weight-based intra prediction sample as an embodiment to which the present disclosure is applied.

FIG. 20 is a diagram illustrating an inter prediction mode based linear interpolation prediction method according to an embodiment of the present disclosure.

FIG. 21 is a diagram more specifically illustrating an intra prediction unit according to an embodiment of the present disclosure.

FIG. 22 is a structure diagram of a content streaming system as an embodiment to which the present disclosure is applied.

### MODE FOR INVENTION

Hereinafter, preferred embodiments of the disclosure will be described by reference to the accompanying drawings. The description that will be described below with the accompanying drawings is to describe exemplary embodiments of the disclosure, and is not intended to describe the only embodiment in which the disclosure may be implemented. The description below includes particular details in order to provide perfect understanding of the disclosure. However, it is understood that the disclosure may be embodied without the particular details to those skilled in the art.

In some cases, in order to prevent the technical concept of the disclosure from being unclear, structures or devices which are publicly known may be omitted, or may be depicted as a block diagram centering on the core functions of the structures or the devices.

Further, although general terms widely used currently are selected as the terms in the disclosure as much as possible, a term that is arbitrarily selected by the applicant is used in a specific case. Since the meaning of the term will be clearly described in the corresponding part of the description in such a case, it is understood that the disclosure will not be simply interpreted by the terms only used in the description of the disclosure, but the meaning of the terms should be figured out.

Specific terminologies used in the description below may be provided to help the understanding of the disclosure. Furthermore, the specific terminology may be modified into other forms within the scope of the technical concept of the disclosure. For example, a signal, data, a sample, a picture, a frame, a block, etc may be properly replaced and interpreted in each coding process.

Hereinafter, in this disclosure, a “processing unit” means a unit by which an encoding/decoding processing process, such as prediction, transform and/or quantization, is performed. Hereinafter, for convenience of description, a processing unit may also be called a “processing block” or “block.”

A processing unit may be construed as a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as a unit for a luma component or a unit for a chroma component. For example, a processing unit may correspond to a coding tree block (CTB), coding block (CB), prediction block (PB) or transform block (TB) for a luma component. Alternatively, a processing unit may correspond to a coding tree block (CTB), coding block (CB), prediction block (PB) or transform block (TB) for a chroma component. Furthermore, the disclosure is not limited thereto, and a processing unit may be construed as a meaning including a unit for a luma component and a unit for a chroma component.

Furthermore, a processing unit is not essentially limited to a block of a square, but may have a polygon form having three or more vertexes.

Furthermore, hereinafter, in this disclosure, a pixel or pixel element is collected referred to as a sample. Furthermore, using a sample may mean using a pixel value or a pixel element value.

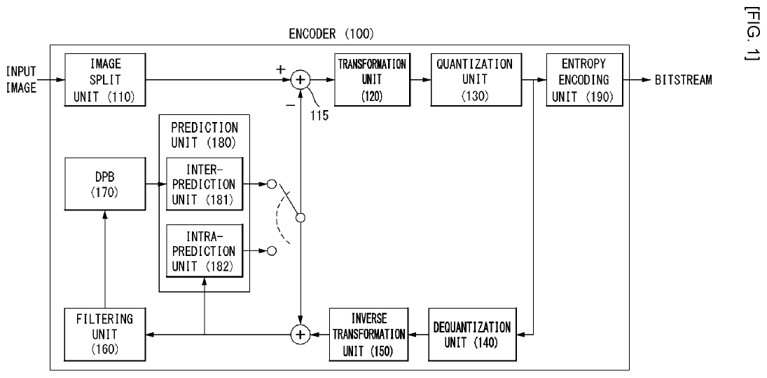

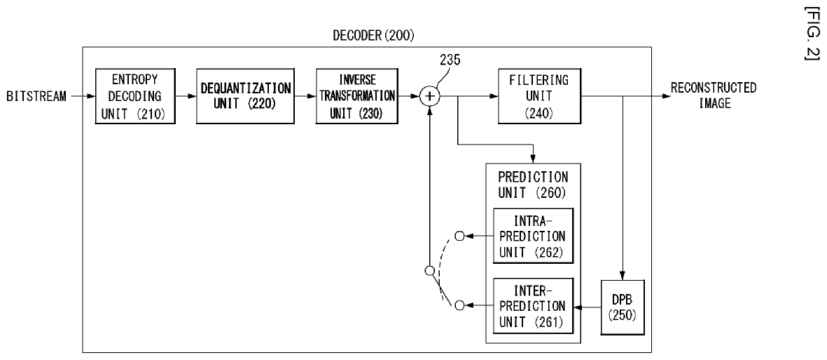

FIG. 1 is an embodiment to which the disclosure is applied, and shows a schematic block diagram of an encoder in which the encoding of a still image or moving image signal is performed.

Referring to FIG. 1, an encoder 100 may include an image split unit 110, a subtraction unit 115, a transformation unit 120, a quantization unit 130, a dequantization unit 140, an inverse transformation unit 150, a filtering unit 160, a decoded picture buffer (DPB) 170, a prediction unit 180 and an entropy encoding unit 190. Furthermore, the prediction unit 180 may include an inter prediction unit 181 and an intra prediction unit 182.

The image split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., inter prediction unit 181 or intra prediction unit 182), from the input video signal. The generated residual signal (or residual block) is transmitted to the transformation unit 120.

The transformation unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transformation unit 120 may generate the transform coefficients by performing transform using a determined transform scheme depending on a prediction mode applied to the residual block and the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal that is outputted from the quantization unit 130 may be used for generating a prediction signal. For example, by applying dequantization and inverse transformation to the quantized signal through the dequantization unit 140 and the inverse transformation unit 150, the residual signal may be reconstructed. By adding the reconstructed residual signal to the prediction signal that is outputted from the inter prediction unit 181 or the intra prediction unit 182, a reconstructed signal may be generated.

Meanwhile, during such a compression process, adjacent blocks are quantized by different quantization parameters from each other, and accordingly, an artifact in which block boundaries are shown may occur. Such a phenomenon is referred to blocking artifacts, which is one of the important factors for evaluating image quality. In order to decrease such an artifact, a filtering process may be performed. Through such a filtering process, the blocking artifact is removed and the error for the current picture is decreased at the same time, thereby the image quality being improved.

The filtering unit 160 applies filtering to the reconstructed signal, and outputs it through a play-back device or transmits it to the decoded picture buffer 170. The filtered signal transmitted to the decoded picture buffer 170 may be used as a reference picture in the inter prediction unit 181. As such, by using the filtered picture as a reference picture in an inter picture prediction mode, the encoding rate as well as the image quality may be improved.

The decoded picture buffer 170 may store the filtered picture in order to use it as a reference picture in the inter prediction unit 181.

The inter prediction unit 181 performs a temporal prediction and/or a spatial prediction by referencing the reconstructed picture in order to remove a temporal redundancy and/or a spatial redundancy. In this case, since the reference picture used for performing a prediction is a transformed signal that goes through the quantization or the dequantization by a unit of block when being encoded/decoded previously, there may exist blocking artifact or ringing artifact.

Accordingly, in order to solve the performance degradation owing to the discontinuity of such a signal or the quantization, by applying a low pass filter to the inter prediction unit 181, the signals between pixels may be interpolated by a unit of sub-pixel. Herein, the sub-pixel means a virtual pixel that is generated by applying an interpolation filter, and an integer pixel means an actual pixel that is existed in the reconstructed picture. As a method of interpolation, a linear interpolation, a bi-linear interpolation, a wiener filter, and the like may be applied.

The interpolation filter may be applied to the reconstructed picture, and may improve the accuracy of prediction. For example, the inter prediction unit 181 may perform prediction by generating an interpolation pixel by applying the interpolation filter to the integer pixel, and by using the interpolated block that includes interpolated pixels as a prediction block.

The intra prediction unit 182 predicts the current block by referring to the samples adjacent the block that is to be encoded currently. The intra prediction unit 182 may perform the following procedure in order to perform the intra prediction. First, the intra prediction unit 182 may prepare a reference sample that is required for generating a prediction signal. Furthermore, the intra prediction unit 182 may generate a prediction signal by using the reference sample prepared. After, the intra prediction unit 182 may encode the prediction mode. In this case, the reference sample may be prepared through reference sample padding and/or reference sample filtering. Since the reference sample goes through the prediction and the reconstruction process, there may be a quantization error. Accordingly, in order to decrease such an error, the reference sample filtering process may be performed for each prediction mode that is used for the intra prediction.

In particular, the intra prediction unit 182 according to the disclosure may perform intra prediction on a current block by linearly interpolating prediction sample values generated based on the intra prediction mode of the current block. The intra prediction unit 182 is described in more detail later.

The prediction signal (or prediction block) generated through the inter prediction unit 181 or the intra prediction unit 182 may be used to generate a reconstructed signal (or reconstructed block) or may be used to generate a residual signal (or residual block).

FIG. 2 is an embodiment to which the disclosure is applied, and shows a schematic block diagram of a decoder in which the encoding of a still image or moving image signal is performed.

Referring to FIG. 2, a decoder 200 may include an entropy decoding unit 210, a dequantization unit 220, an inverse transformation unit 230, an addition unit 235, a filtering unit 240, a decoded picture buffer (DPB) 250 and a prediction unit 260. Furthermore, the prediction unit 260 may include an inter prediction unit 261 and an intra prediction unit 262.

Furthermore, the reconstructed video signal outputted through the decoder 200 may be played through a play-back device.

The decoder 200 receives the signal (i.e., bit stream) outputted from the encoder 100 shown in FIG. 1, and the entropy decoding unit 210 performs an entropy decoding operation of the received signal.

The dequantization unit 220 acquires a transform coefficient from the entropy-decoded signal using quantization step size information.

The inverse transformation unit 230 obtains a residual signal (or residual block) by inversely transforming transform coefficients using an inverse transform scheme.

The adder 235 adds the obtained residual signal (or residual block) to the prediction signal (or prediction block) output by the prediction unit 260 (i.e., inter prediction unit 261 or intra prediction unit 262), thereby generating a reconstructed signal (or reconstructed block).

The filtering unit 240 applies filtering to the reconstructed signal (or reconstructed block) and outputs it to a playback device or transmits it to the decoding picture buffer unit 250. The filtered signal transmitted to the decoding picture buffer unit 250 may be used as a reference picture in the inter prediction unit 261.

In this disclosure, the embodiments described in the filtering unit 160, the inter prediction unit 181 and the intra prediction unit 182 of the encoder 100 may also be applied to the filtering unit 240, the inter prediction unit 261 and the intra prediction unit 262 of the decoder, respectively, in the same way.

In particular, the intra prediction unit 262 according to the disclosure may perform intra prediction on a current block by linearly interpolating prediction sample values generated based on an intra prediction mode of the current block. The intra prediction unit 262 is described in detail later.

[symbol]

In general, the block-based image compression method is used in a technique (e.g., HEVC) for compressing a still image or a moving image. A block-based image compression method is a method of processing an image by splitting the video into specific block units, and may decrease the capacity of memory and a computational load.

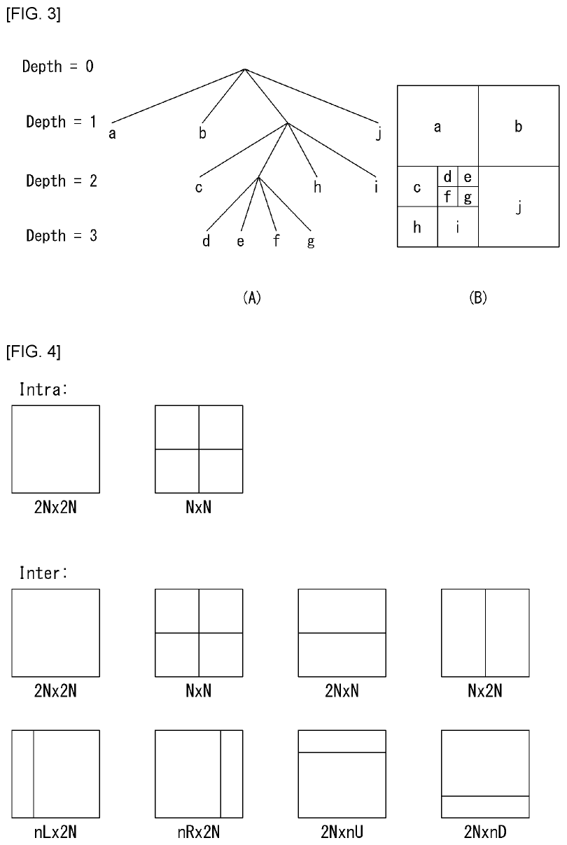

FIG. 3 is a diagram for illustrating the split structure of a coding unit that may be applied to the disclosure.

The encoder splits a single image (or picture) in a coding tree unit (CTU) of a rectangle form, and sequentially encodes a CTU one by one according to raster scan order.

In HEVC, the size of a CTU may be determined to be one of 64×64, 32×32 and 16×16. The encoder may select and use the size of CTU according to the resolution of an input video or the characteristics of an input video. A CTU includes a coding tree block (CTB) for a luma component and a CTB for two chroma components corresponding to the luma component.

One CTU may be split in a quad-tree structure. That is, one CTU may be split into four units, each having a half horizontal size and half vertical size while having a square form, thereby being capable of generating a coding unit (CU). The split of the quad-tree structure may be recursively performed. That is, a CU is hierarchically from one CTU in a quad-tree structure.

A CU means a basic unit for a processing process of an input video, for example, coding in which intra/inter prediction is performed. A CU includes a coding block (CB) for a luma component and a CB for two chroma components corresponding to the luma component. In HEVC, the size of a CU may be determined to be one of 64×64, 32×32, 16×16 and 8×8.

Referring to FIG. 3, a root node of a quad-tree is related to a CTU. The quad-tree is split until a leaf node is reached, and the leaf node corresponds to a CU.

This is described in more detail. A CTU corresponds to a root node and has the deepest depth (i.e., depth=0) value. A CTU may not be split depending on the characteristics of an input video. In this case, the CTU corresponds to a CU.

A CTU may be split in a quad-tree form. As a result, lower nodes of a depth 1 (depth=1) are generated. Furthermore, a node (i.e., a leaf node) no longer split from the lower node having the depth of 1 corresponds to a CU. For example, in FIG. 3(b), a CU(a), CU(b) and CU(j) corresponding to nodes a, b and j have been once split from a CTU, and have a depth of 1.

At least one of the nodes having the depth of 1 may be split in a quad-tree form again. As a result, lower nodes of a depth 2 (i.e., depth=2) are generated. Furthermore, a node (i.e., leaf node) no longer split from the lower node having the depth of 2 corresponds to a CU. For example, in FIG. 3(b), a CU(c), CU(h) and CU(i) corresponding to nodes c, h and i have been twice split from the CTU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from the lower node having the depth of 3 corresponds to a CU. For example, in FIG. 3(b), a CU(d), CU(e), CU(f) and CU(g) corresponding to nodes d, e, f and g have been split from the CTU three times, and have a depth of 3.

In the encoder, a maximum size or minimum size of a CU may be determined according to the characteristics of a video image (e.g., resolution) or by considering encoding rate. Furthermore, information about the size or information capable of deriving the size may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents the split count and/or degree of a CU, the depth information may include information about the size of a CU.

Since the LCU is split in a quad-tree form, the size of the SCU may be obtained using the size of the LCU and maximum depth information. Alternatively, the size of the LCU may be obtained using the size of the SCU and maximum depth information of a tree.

For a single CU, information (e.g., a split CU flag (split_cu_flag)) indicating whether the corresponding CU is split may be forwarded to the decoder. The split information is included in all of CUs except the SCU. For example, when the value of the flag indicating whether to split is ‘1’, the corresponding CU is further split into four CUs, and when the value of the flag that represents whether to split is ‘0’, the corresponding CU is not split any more, and the processing process for the corresponding CU may be performed.

As described above, the CU is a basic unit of the coding in which the intra prediction or the inter prediction is performed. The HEVC splits the CU in a prediction unit (PU) for coding an input video more effectively.

The PU is a basic unit for generating a prediction block, and even in a single CU, the prediction block may be generated in different way by a unit of a PU. However, the intra prediction and the inter prediction are not used together for the PUs that belong to a single CU, and the PUs that belong to a single CU are coded by the same prediction method (i.e., intra prediction or the inter prediction).

The PU is not split in the Quad-tree structure, but is split once in a single CU in a predetermined form. This will be described by reference to the drawing below.

FIG. 4 is a diagram for illustrating a prediction unit that may be applied to the disclosure.

A PU is differently split depending on whether the intra prediction mode is used or the inter prediction mode is used as the coding mode of the CU to which the PU belongs.

FIG. 4(a) illustrates a PU of the case where the intra prediction mode is used, and FIG. 4(b) illustrates a PU of the case where the inter prediction mode is used.

Referring to FIG. 4(a), assuming the case where the size of a single CU is 2N×2N (N=4, 8, 16 and 32), a single CU may be split into two types (i.e., 2N×2N or N×N).

In this case, in the case where a single CU is split into the PU of 2N×2N form, it means that only one PU is existed in a single CU.

In contrast, in the case where a single CU is split into the PU of N×N form, a single CU is split into four PUs, and different prediction blocks are generated for each PU unit. However, such a PU split may be performed only in the case where the size of a CB for the luma component of a CU is a minimum size (i.e., if a CU is the SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in intra prediction, the PU split of N×N form may be performed only in the case where the size of a CB for the luma component of a CU is a minimum size (i.e., if a CU is the SCU).

Inter-prediction supports the PU split of a 2N×N form in the horizontal direction and an N×2N form in the vertical direction.

In addition, the inter prediction supports the PU split in the form of nL×2N, nR×2N, 2N×nU and 2N×nD, which is asymmetric motion split (AMP). In this case, ‘n’ means ¼ value of 2N. However, the AMP may not be used in the case where a CU to which a PU belongs is a CU of minimum size.

In order to efficiently encode an input video in a single CTU, the optimal split structure of a coding unit (CU), prediction unit (PU) and transform unit (TU) may be determined based on a minimum rate-distortion value through the processing process as follows. For example, as for the optimal CU split process in a 64×64 CTU, the rate-distortion cost may be calculated through the split process from a CU of a 64×64 size to a CU of an 8×8 size. A detailed process is as follows.

1) The optimal split structure of a PU and TU that generates a minimum rate distortion value is determined by performing inter/intra prediction, transformation/quantization, dequantization/inverse transformation and entropy encoding on a CU of a 64×64 size.

2) The optimal split structure of a PU and TU is determined by splitting a 64×64 CU into four CUs of a 32×32 size and generating a minimum rate distortion value for each 32×32 CU.

3) The optimal split structure of a PU and TU is determined by further splitting a 32×32 CU into four CUs of a 16×16 size and generating a minimum rate distortion value for each 16×16 CU.

4) The optimal split structure of a PU and TU is determined by further splitting a 16×16 CU into four CUs of an 8×8 size and generating a minimum rate distortion value for each 8×8 CU.

The optimal split structure of a CU in a 16×16 block is determined by comparing the rate-distortion value of the 16×16 CU obtained in the process of 3) with the addition of the rate-distortion value of the four 8×8 CUs obtained in the process of 4). This process is also performed on the remaining three 16×16 CUs in the same manner.

6) The optimal split structure of a CU in a 32×32 block is determined by comparing the rate-distortion value of the 32×32 CU obtained in the process of 2) with the addition of the rate-distortion value of the four 16×16 CUs obtained in the process of 5). This process is also performed on the remaining three 32×32 CUs in the same manner.

7) Lastly, the optimal split structure of a CU in a 64×64 block is determined by comparing the rate-distortion value of the 64×64 CU obtained in the process of 1) with the addition of the rate-distortion value of the four 32×32 CUs obtained in the process of 6).

In an intra prediction mode, a prediction mode is selected in a PU unit, and prediction and reconstruction are performed on the selected prediction mode in an actual TU unit.

A TU means a basic unit by which actual prediction and reconstruction are performed. A TU includes a transform block (TB) for a luma component and two chroma components corresponding to the luma component.

In the example of FIG. 3, as if one CTU is split in a quad-tree structure to generate a CU, a TU is hierarchically split from one CU to be coded in a quad-tree structure.

A TU is split in the quad-tree structure, and a TU split from a CU may be split into smaller lower TUs. In HEVC, the size of a TU may be determined to be any one of 32×32, 16×16, 8×8 and 4×4.

Referring back to FIG. 3, it is assumed that the root node of the quad-tree is related to a CU. The quad-tree is split until a leaf node is reached, and the leaf node corresponds to a TU.

This is described in more detail. A CU corresponds to a root node and has the deepest depth (i.e., depth=0) value. A CU may not be split depending on the characteristics of an input video. In this case, the CU corresponds to a TU.

A CU may be split in a quad-tree form. As a result, lower nodes, that is, a depth 1 (depth=1), are generated. Furthermore, a node (i.e., leaf node) no longer split from the lower node having the depth of 1 corresponds to a TU. For example, in FIG. 3(b), a TU(a), TU(b) and TUU) corresponding to the nodes a, b and j have been once split from a CU, and have a depth of 1.

At least one of the nodes having the depth of 1 may be split again in a quad-tree form. As a result, lower nodes, that is, a depth 2 (i.e., depth=2), are generated. Furthermore, a node (i.e., leaf node) no longer split from the lower node having the depth of 2 corresponds to a TU. For example, in FIG. 3(b), a TU(c), TU(h) and TU(i) corresponding to the nodes c, h and i have been split twice from the CU, and have a depth of 2.

Furthermore, at least one of the nodes having the depth of 2 may be split in a quad-tree form again. As a result, lower nodes having a depth of 3 (i.e., depth=3) are generated. Furthermore, a node (i.e., leaf node) no longer split from a lower node having the depth of 3 corresponds to a CU. For example, in FIG. 3(b), a TU(d), TU(e), TU(f), TU(g) corresponding to the nodes d, e, f and g have been split from the CU three times, and have the depth of 3.

A TU having a tree structure may be hierarchically split based on predetermined highest depth information (or highest level information). Furthermore, each split TU may have depth information. The depth information may also include information about the size of the TU because it indicates the number of times and/or degree that the TU has been split.

With respect to one TU, information (e.g., a split TU flag (split_transform_flag)) indicating whether a corresponding TU has been split may be transferred to the decoder. The split information is included in all TUs other than a TU of the least size. For example, if the value of the flag indicating whether a TU has been split is ‘1’, the corresponding TU is split into four TUs. If the value of the flag is ‘0’, the corresponding TU is no longer split.

[symbol]

### Prediction

In order to reconstruct a current processing unit on which decoding is performed, the decoded part of a current picture including the current processing unit or other pictures may be used.

A picture (slice) using only a current picture for reconstruction, that is, performing only intra prediction, may be referred to as an intra picture or I picture (slice). A picture (slice) using the greatest one motion vector and reference index in order to predict each unit may be referred to as a predictive picture or P picture (slice). A picture (slice) using a maximum of two motion vectors and reference indices in order to predict each unit may be referred to as a bi-predictive picture or B picture (slice).

Intra-prediction means a prediction method of deriving a current processing block from a data element (e.g., sample value, etc.) of the same decoded picture (or slice). That is, intra prediction means a method of predicting a pixel value of the current processing block with reference to reconstructed regions within a current picture.

Inter-prediction means a prediction method of deriving a current processing block based on a data element (e.g., sample value or motion vector) of a picture other than a current picture. That is, inter prediction means a method of predicting the pixel value of the current processing block with reference to reconstructed regions within another reconstructed picture other than a current picture.

Hereinafter, intra prediction is described in more detail.

[symbol]

### Intra-prediction

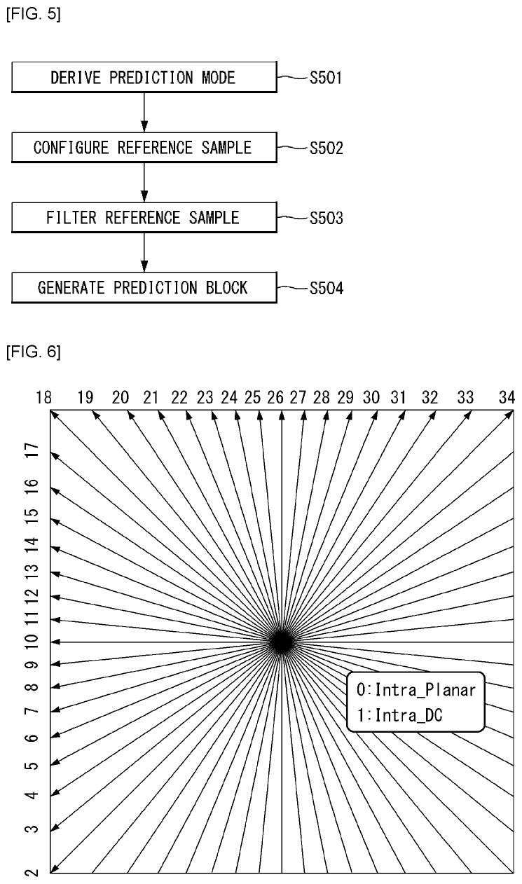

FIG. 5 is an embodiment to which the disclosure is applied and is a diagram illustrating an intra prediction method.

Referring to FIG. 5, the decoder derives an intra prediction mode of a current processing block (S501).

In intra prediction, there may be a prediction direction for the location of a reference sample used for prediction depending on a prediction mode.

An intra prediction mode having a prediction direction is referred to as intra angular prediction mode “Intra_Angular prediction mode.” In contrast, an intra prediction mode not having a prediction direction includes an intra planar (INTRA_PLANAR) prediction mode and an intra DC (INTRA_DC) prediction mode.

Table 1 illustrates intra prediction modes and associated names, and FIG. 6 illustrates prediction directions according to intra prediction modes.

TABLE 1

| Intra prediction | |
|---|---|
| mode | Associated names |
| 0 | INTRA_PLANAR |
| 1 | INTRA_DC |
| 2 . . . 34 | INTRA_ANGULAR2 . . . INTRA_ANGULAR34 |

In intra prediction, prediction may be on a current processing block based on a derived prediction mode. A reference sample used for prediction and a detailed prediction method are different depending on a prediction mode. Accordingly, if a current block is encoded in an intra prediction mode, the decoder derives the prediction mode of a current block in order to perform prediction.

The decoder checks whether neighboring samples of the current processing block may be used for prediction and configures reference samples to be used for prediction (S502).

In intra prediction, neighboring samples of a current processing block mean a sample neighboring the left boundary of the current processing block of an nSxnS size, a total of 2×nS samples neighboring the left bottom of the current processing block, a sample neighboring the top boundary of the current processing block, a total of 2×nS samples neighboring the top right of the current processing block, and one sample neighboring the top left of the current processing block.

However, some of the neighboring samples of the current processing block have not yet been decoded or may not be available. In this case, the decoder may configure reference samples to be used for prediction by substituting unavailable samples with available samples.

The decoder may perform the filtering of the reference samples based on the intra prediction mode (S503).

Whether the filtering of the reference samples will be performed may be determined based on the size of the current processing block. Furthermore, a method of filtering the reference samples may be determined by a filtering flag transferred by the encoder.

The decoder generates a prediction block for the current processing block based on the intra prediction mode and the reference samples (S504). That is, the decoder generates the prediction block for the current processing block (i.e., generates a prediction sample) based on the intra prediction mode derived in the intra prediction mode derivation step S501 and the reference samples obtained through the reference sample configuration step S502 and the reference sample filtering step S503.

If the current processing block has been encoded in the INTRA_DC mode, in order to minimize the discontinuity of the boundary between processing blocks, at step S504, the left boundary sample of the prediction block (i.e., a sample within the prediction block neighboring the left boundary) and the top boundary sample (i.e., a sample within the prediction block neighboring the top boundary) may be filter.

Furthermore, at step S504, in the vertical mode and horizontal mode of the intra angular prediction modes, as in the INTRA_DC mode, filtering may be applied to the left boundary sample or the top boundary sample.

This is described in more detail. If the current processing block has been encoded in the vertical mode or the horizontal mode, the value of a prediction sample may be derived based on a reference sample located in a prediction direction. In this case, a boundary sample that belongs to the left boundary sample or top boundary sample of the prediction block and that is not located in the prediction direction may neighbor a reference sample not used for prediction. That is, the distance from the reference sample not used for prediction may be much closer than the distance from the reference sample used for prediction.

Accordingly, the decoder may adaptively apply filtering on left boundary samples or top boundary samples depending on whether an intra prediction direction is a vertical direction or a horizontal direction. That is, the decoder may apply filtering on the left boundary samples if the intra prediction direction is the vertical direction, and may apply filtering on the top boundary samples if the intra prediction direction is the horizontal direction.

[symbol]

### Linear Intra Prediction (LIP)

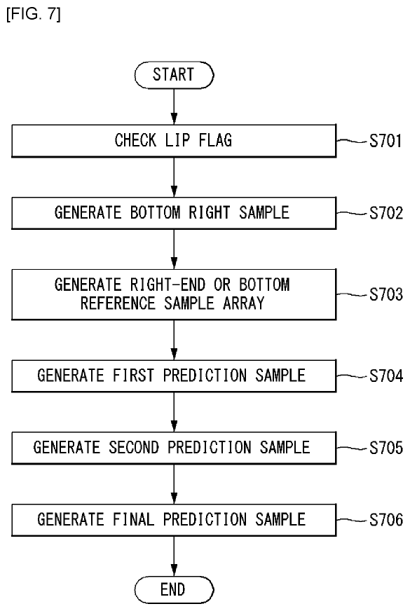

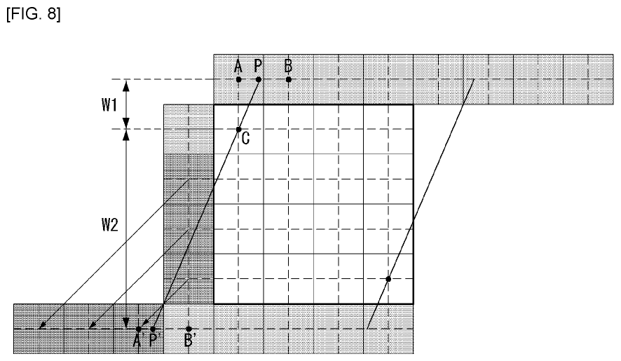

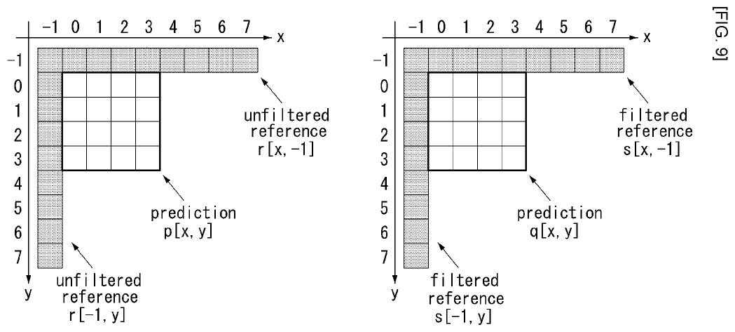

FIGS. 7 and 8 are diagrams for describing a linear interpolation prediction method as an embodiment to which the present disclosure is applied.

Referring to FIGS. 7 and 8, the method is described mainly for the decoder for convenience of description, but the linear interpolation prediction method proposed in the present disclosure may be equally performed even in the encoder.

The decoder parses (or confirms) an LIP flag indicating whether linear intra prediction (LIP) (or linear interpolation intra prediction) is applied to a current block from a bitstream received from the encoder (S701).

In an embodiment, the decoder may derive an intra prediction mode of the current block before step S701 and derive the intra prediction mode of the current block after step S701. In other words, before or after step S701, a step of deriving the intra prediction mode may be added. In addition, the step of deriving the intra prediction mode may include parsing an MPM flag indicating whether a most probable mode (MPM) is applied to the current block and parsing an index indicating a prediction mode applied to the intra prediction of the current block in an MPM candidate or residual prediction mode candidate according to whether the MPM is applied.

The decoder generates a lower right reference end reference sample adjacent to a lower right side of the current block (S702). The decoder may generate the lower right end reference sample by using various methods.

The decoder generates a right reference sample array or a lower reference sample array by using a reconstructed reference sample around the current block and the lower right end reference sample generated in step S702 (S703). In the present disclosure, the right reference sample array may be collectively referred to as the right reference sample, a right end reference sample, a right end reference sample array, etc., and a lower reference sample array may be collectively referred to as a lower reference sample, a lower end reference sample, a lower end reference sample array, etc.

The decoder generates a first prediction sample and a second prediction sample based on the prediction direction of the intra prediction mode of the current block (S704 and S705). Here, the first prediction sample and the second prediction sample mutually represent reference samples positioned at an opposite side to the current block based on the prediction direction. The first prediction sample (may be referred to as a first reference sample) represents a prediction sample generated by using the reference sample determined according to the intra prediction mode of the current block among reconstructed reference samples (left, upper left, and upper reference samples) according to the intra prediction in the related art as described in FIGS. 5 and 6 above. In addition, the second prediction sample (may be referred to as a second reference sample) represents a prediction sample generated by using the reference sample determined according to the intra prediction mode of the current block in the right reference sample array or the lower reference sample array in step S703.

The decoder interpolates (or linearly interpolates) the first prediction sample and the second prediction sample generated in step S704 and S705 to generate a final prediction sample (S706). The decoder weight-adds the first prediction sample and the second prediction sample based on the distances between the current sample and the prediction samples (or reference sample) to generate the final prediction sample.

Referring to FIG. 8, the decoder may generate a first prediction sample P based on the intra prediction mode. Specifically, the decoder may derive the first prediction sample by interpolating (or linearly interpolating) reference sample A and reference sample B determined according to the prediction direction among the upper reference samples. Meanwhile, unlike in FIG. 8, when the reference sample determined according to the prediction direction is positioned at the integer pixel location, the inter-reference sample interpolation may not be performed.

Further, the decoder may generate a second prediction sample P′ based on the intra prediction mode. Specifically, the decoder determines reference sample A′ and reference sample B′ according to the prediction direction of the intra prediction mode of the current block among the lower reference samples and linearly interpolates reference sample A′ and reference sample B′ to derive the second prediction sample. Meanwhile, unlike in FIG. 8, when the reference sample determined according to the prediction direction is positioned at the integer pixel location, the inter-reference sample interpolation may not be performed.

The decoder interpolates (or linearly interpolates) the first prediction sample and the second prediction sample to generate a final prediction sample. The decoder weight-adds the first prediction sample and the second prediction sample based on the distances between the current sample and the prediction samples (or reference sample) to generate the final prediction sample.

In this case, the encoder/decoder may calculate the weight applied to the first and second prediction samples based on a vertical or horizontal distance ratio as illustrated in FIG. 8. Further, unlike illustrated in FIG. 8, the encoder/decoder may calculate the weight applied to the first and second prediction samples based on a ratio between an actual distance between the current sample and the first prediction sample and an actual distance between the current sample and the second prediction sample.

[symbol]

### Position-Dependent Intra Prediction Combination (PDPC)

FIG. 9 is an embodiment to which the disclosure may be applied and is a diagram for describing a position-dependent intra prediction combination method.

In an embodiment of the disclosure, a position-dependent intra prediction combination (hereinafter referred to as a “PDPC”) indicates a method of generating the final prediction sample using an unfiltered reference sample and a filtered reference sample.

Referring to FIG. 9, r indicates an unfiltered reference sample sequence, and s indicates a filtered reference sample sequence. For example, the final prediction sample generated using an unfiltered reference sample and a filtered reference sample may be calculated using Equation 1.

$$[ Equation 1 ]$$

$$p [ x , y ] = \{ ( {c}_{1}^{( v )} ≫ ⌊ y / d ⌋ ) r [ x , - 1 ] - ( {c}_{2}^{( v )} ≫ ⌊ y / d ⌋ ) r [ - 1 , - 1 ] + ( {c}_{1}^{( h )} ≫ ⌊ x / d ⌋ ) r [ - 1 , y ] - ( {c}_{2}^{( h )} ≫ ⌊ x / d ⌋ ) r [ - 1 , - 1 ] + b [ x , y ] q [ x , y ] + 64 \} ≫ 7$$

In this case, c₁^{v}, c₂^{v},c₁^{h}, c₂^{h} indicate prediction parameters (or weight parameters) applied to an unfiltered reference sample, and may be previously stored in the encoder/decoder. Furthermore, the prediction parameter may be pre-defined for each prediction direction and/or each block size. Furthermore, a d value may be a value preset based on a block size. Furthermore, b[x,y] indicates a normalization factor, and may be calculated using Equation 2, for example.

b[x,y]=128−(c₁^{(v)}»└y/d┘)+(c₂^{(v)}»└y/d┘)−(c₁^{(v)}»└y/d┘)+(c₂^{(h)}»└y/d┘) [Equation 2]

Furthermore, a reference sample may be filtered by applying various and several filters (e.g., a low bandpass filter). For example, a reference sample used for a PDPC may be filtered using Equation 3.

s=a r+(1−a)(hₖ*r) [Equation 3]

In this case, “a” indicates a prediction parameter (or weight parameter), and “k” indicates a filter index. The prediction parameter and the filter index k may be defined for each prediction direction and each block size.

[symbol]

### EMBODIMENT 1

An embodiment of the present disclosure provides a weight-based intra prediction method of generating a prediction block by applying a weight to a reference sample or a prediction sample. Hereinafter, in the present disclosure, weight-based intra prediction represents a method for generating the prediction sample using the reference sample to which the weight is applied. The weight-based intra prediction may be referred to as weight-based intra prediction, weighted intra prediction, weighted intra prediction, etc. The weight-based intra prediction may be, for example, any one of PDPC, linear interpolation intra prediction (LIP), bi-linear interpolation intra prediction, or multi reference sample line intra prediction. In addition, intra prediction other than the weighted intra prediction may be referred to as general intra prediction (or general intra prediction). For example, the general intra prediction as an intra prediction method used in the existing image compression technology may be an intra prediction method using one reference sample (or interpolated reference sample) determined according to a prediction direction.

First, the encoder/decoder may generate the first prediction sample using the reference sample (or prediction sample) to which the weight is applied as shown in Equation 4 below. For example, when the method proposed by the present disclosure is applied to the linear interpolation intra prediction or the bi-linear interpolation intra prediction, the first prediction sample may be a prediction sample generated using the reference sample determined according to the intra prediction mode of the current block among reconstructed reference samples. Alternatively, for example, when the method proposed by the present disclosure is applied to the PDPC, the first prediction sample may be a reference sample which is not filtered.

$$Predictor Sample\_R = ( {\sum }_{r = 0}^{N - 1} ( {Sign}_{r} * {Weight}_{r} * {Reference}_{r} ) ) * \frac{1}{{\sum }_{r = 0}^{N - 1} {Weight}_{r}} \qquad [ Equation 4 ]$$

Here, r represents a horizontal or vertical coordinate of a current sample. In Equation 4, the weight may be preconfigured based on a location or distance of the current sample.

In addition, the encoder/decoder may generate the first prediction sample using the prediction sample (or reference sample) to which the weight is applied as shown in Equation 5 below. For example, when the method proposed by the present disclosure is applied to the linear interpolation intra prediction or the bi-linear interpolation intra prediction, the second prediction sample may be a prediction sample generated using the first prediction sample and the reference sample positioned on an opposite side to the current block based on the prediction direction of the prediction mode. Alternatively, for example, when the method proposed by the present disclosure is applied to the PDPC, the second prediction sample may be a prediction sample generated using a filtered reference sample.

$$Predictor Sample\_P = ( {\sum }_{p = 0}^{M - 1} ( {Sign}_{p} * {Weight}_{p} * {Predictor}_{p} ) ) * \frac{1}{{\sum }_{p = 0}^{M - 1} {Weight}_{p}} \qquad [ Equation 5 ]$$

Here, r represents the horizontal or vertical coordinate of the current sample. In Equation 5, the weight may be preconfigured based on the location or distance of the current sample.

The encoder/decoder weight-adds the first prediction sample and the second prediction sample to generate the final prediction sample as shown in Equation 6 below.

Predictor Sample={W*Predictor Sample_R+(1+W)*Predictor Sample_P} [Equation 6]

Here, a W value may represent a weighting factor applied to the first prediction sample defined in Equation 4 above and may have a value (0<=W<=1) between 0 and 1. Alternatively, Equation 6 may be implemented as shown in Equation 7 below.

Predictor Sample={a*Predictor Sample_R+b*Predictor Sample_P+offset}/N [Equation 7]

Here, a and b represent weights applied to the prediction samples generated through Equations 4 and 5, respectively. In addition, N represents a coefficient (or variable) for performing normalization for a prediction value weight-added by using a and b. In addition, an offset may depend on a normalization factor and may have, for example, a value of N/2.

In an embodiment, weight values a and b may be stored in a predefined table and derived in a bitstream transmitted from the encoder to the decoder.

[symbol]

### EMBODIMENT 2

An embodiment of the present disclosure provides a weight-based intra prediction method of generating a prediction block (or enhanced prediction block) by limitedly applying the weight to the reference sample or the prediction sample in a specific prediction mode. In other words, the encoder/decoder may minimize signaling overhead by applying the weight-based intra prediction method only to the specific intra prediction mode among DC, planar, and angular prediction modes constituting the intra prediction mode.

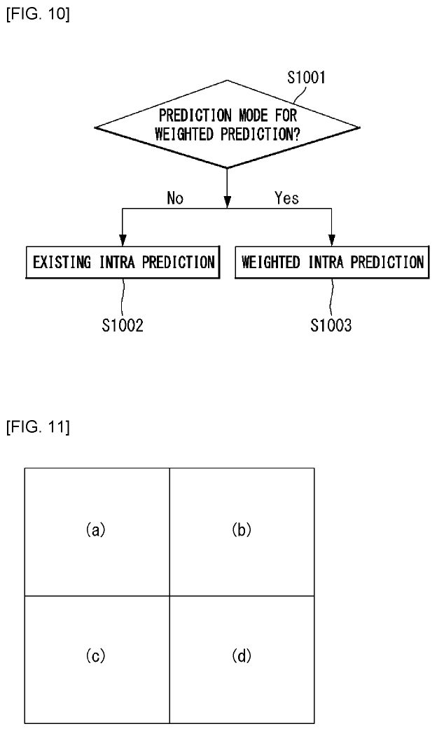

FIG. 10 is a flowchart showing a method for determining whether to apply weight intra prediction based on an intra prediction mode as an embodiment to which the present disclosure is applied.

Referring to FIG. 10, the encoder/decoder checks whether the prediction mode applied to the intra prediction of the current block is a prediction mode for weighted prediction (S1001). For example, the encoder/decoder may apply the weight-based prediction method only to the planar mode and apply the general intra prediction method to the remaining prediction modes.

When the intra prediction mode of the current block is not the prediction mode for the weighted intra prediction, the encoder/decoder generates an intra prediction block by applying the general intra prediction method (S1002). In this case, the methods described in FIGS. 5 and 6 above may be applied.

When the intra prediction mode of the current block is the prediction mode for the weighted intra prediction, the encoder/decoder generates the intra prediction block by applying the weight-based intra prediction method (S1003). In this case, the methods described in FIGS. 7, 8, and 9 above may be applied. According to an embodiment of the present disclosure, it is advantageous in that the existing intra prediction mode may be replaced with the weight-based intra prediction mode without addition of additional information.

[symbol]

### EMBODIMENT 3

In the existing image compression technology, the intra prediction block is generated by just copying a reference sample value according to the intra prediction mode. The prediction block generated by such a method shows a consecutive feature between the prediction samples according to directivity of the prediction mode and an inconsecutive feature depending on a change in reference sample value. In order to solve such a problem, there is a situation in which many types of smoothing (or filtering) methods are under discussion.

In general, the smoothing methods include a method for applying a low pass filter to the prediction block generated through the intra prediction, a method for performing filtering for the intra prediction block by deriving the parameter trained for each intra prediction mode, and the like. Here, in the case of the method for deriving and filtering the parameter trained for each prediction mode as such, it is advantageous in that the parameter may be effectively filtered by adaptively determining a filter according to the prediction mode, but the parameter trained for each prediction mode should be provided, and as a result, there is a problem that a memory usage increases.

Accordingly, an embodiment of the present disclosure provides a method for performing intra prediction using a generalized weight regardless of an intra prediction mode in order to solve such a problem.

Furthermore, an embodiment of the present disclosure provides a weight-based intra prediction method using a weight table applicable to all block sizes.

FIGS. 11 to 13 are diagrams illustrating a generalized weight table used for weight-based intra prediction according to an embodiment of the present disclosure.

Referring to FIGS. 11 to 13, it is assumed that the generalized weight table is a table having a size of 64×64. However, the present disclosure is not limited thereto and generalized weight tables having various sizes may be predetermined.

The encoder/decoder may perform the weighted intra prediction using the generalized weight table as illustrated in FIGS. 11 to 13 in order to solve a memory problem that all parameters should be stored for each prediction mode in the method for smoothing the prediction block through the parameter trained for each prediction mode in the related art.

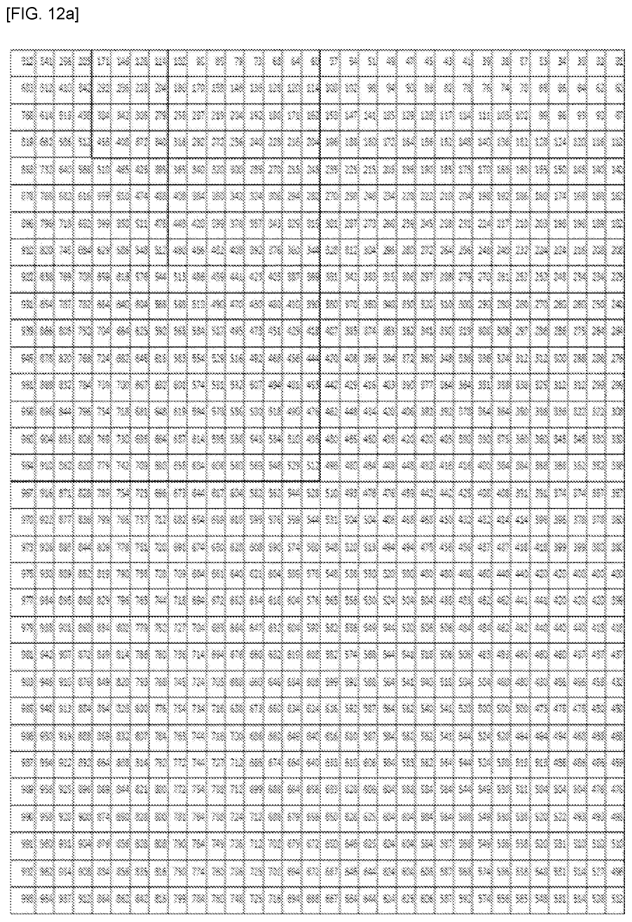

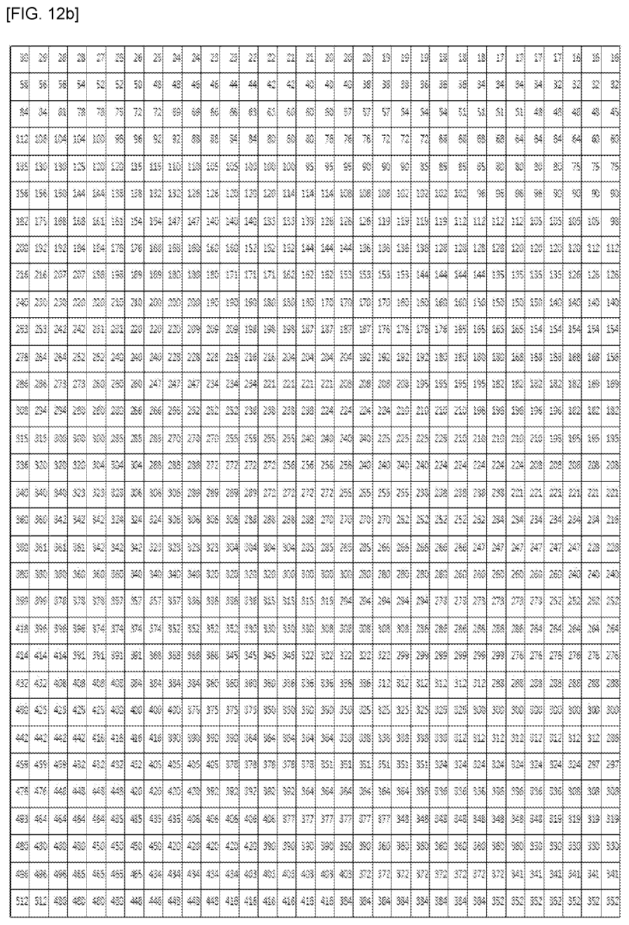

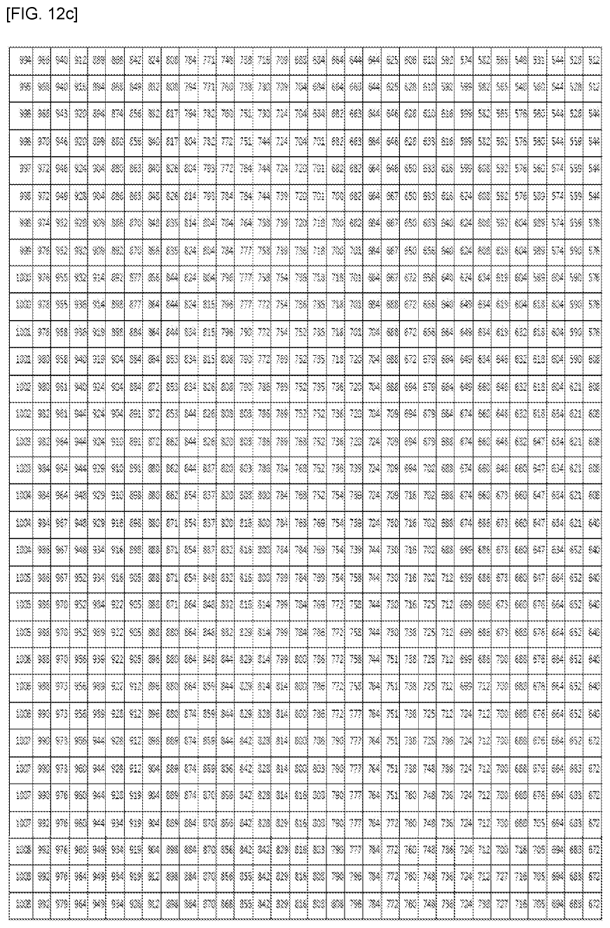

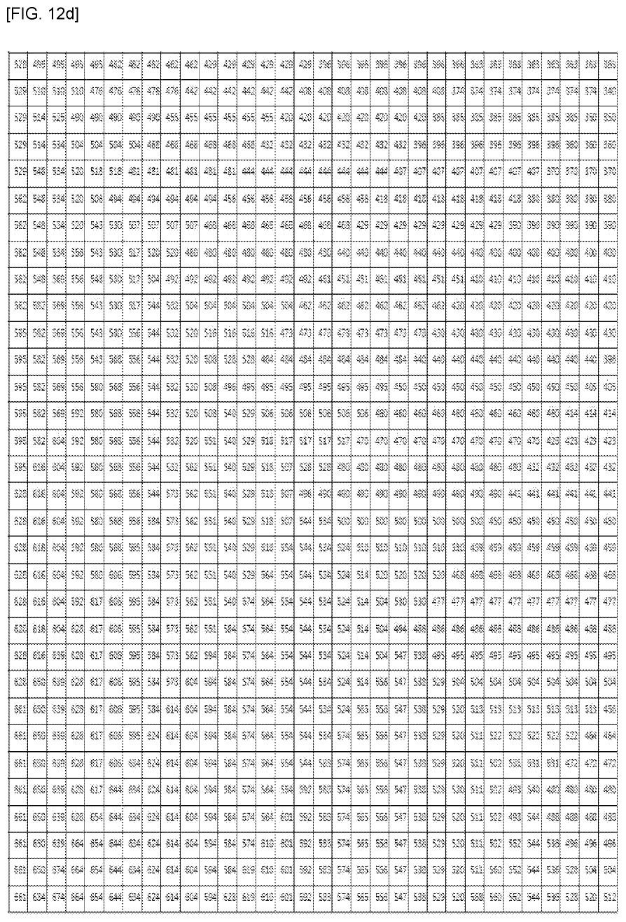

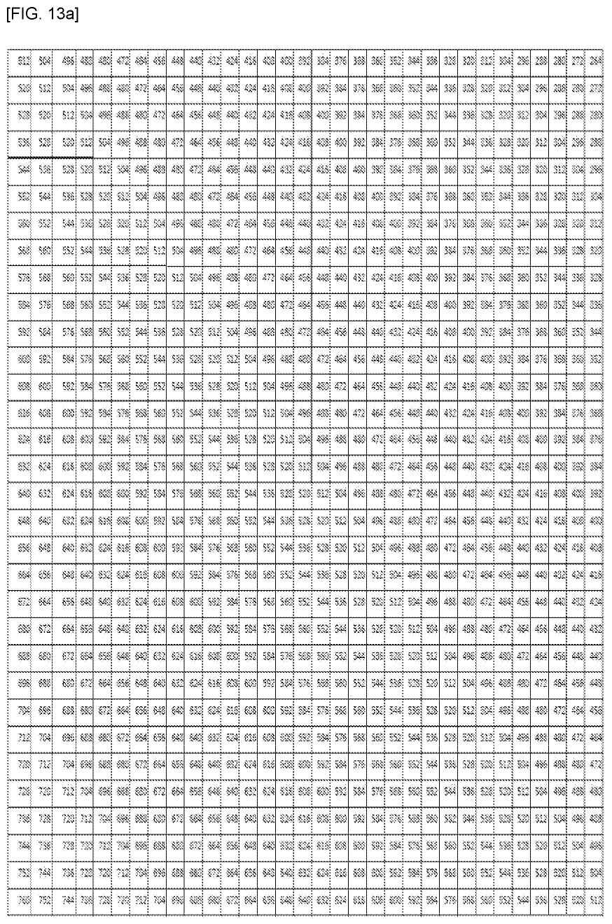

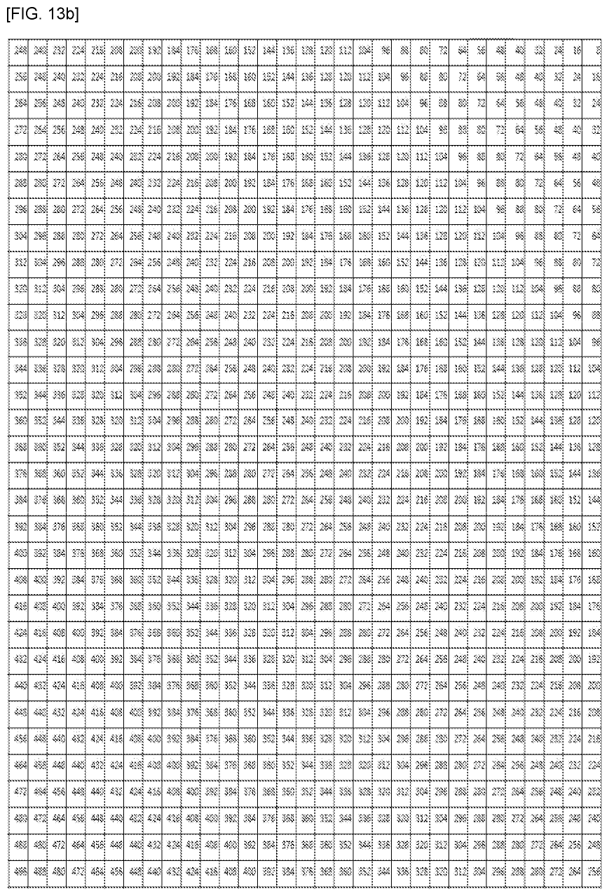

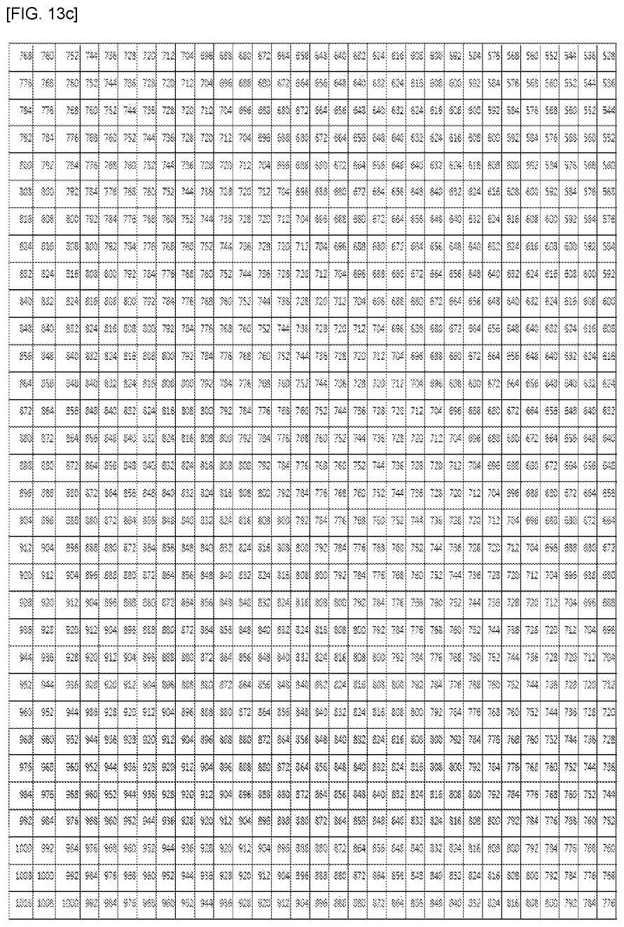

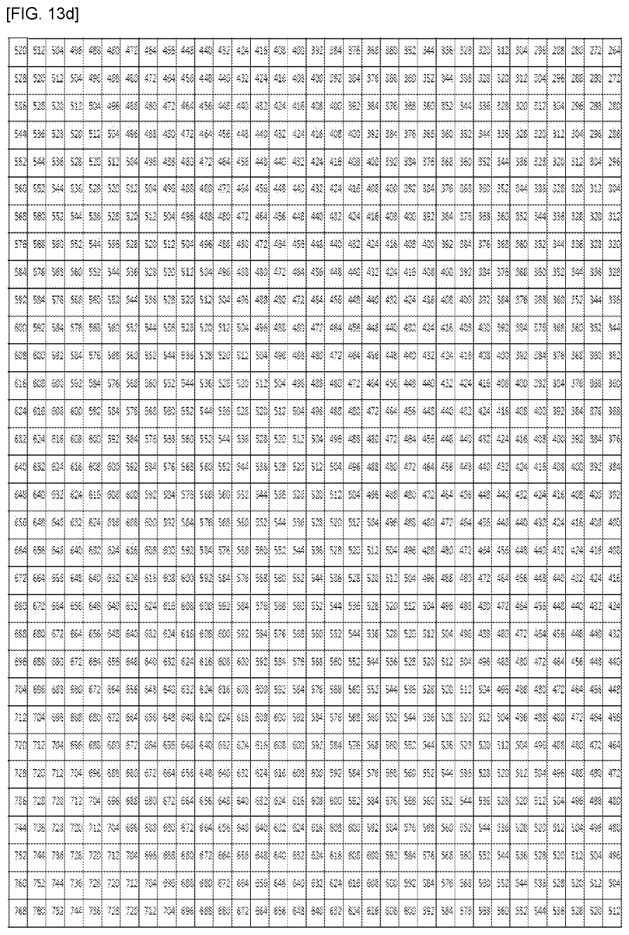

Referring to FIG. 11, for convenience of description, the weight table having the 64×64 size is divided into four 32×32-size tables and expressed. Respective 32×32-size regions (a), (b), (c), and (d) may correspond to FIGS. 12a, 12b, 12c, and 12d or FIGS. 13a, 13b, 13c, and 13d, respectively.

The weight table illustrated in FIG. 12 or 13 shows a weight depending on a horizontal coordinate x and/or vertical coordinate y location of a pixel in the current block. In an embodiment, the encoder/decoder may share the weight table of FIG. 12 or 13 for all size blocks and use the weight table for the weighted intra prediction.

For example, when the current block is a 4×4 block, the encoder/decoder may use a weight for a 4×4 region based on an upper left end of the weight table illustrated in FIG. 12 or 13. Similarly, when the current block is an 8×8 block, the encoder/decoder may use a weight for an 8×8 region based on the upper left end.

Further, in an embodiment, the weight table may be derived based on a distance from a reference pixel determined according the prediction direction of the specific prediction mode. In addition, coefficients of the weight table may be normalized to integer values for improvement of complexity of a computation.

In smoothing technology using a low pass filter type filter in the relate dart, since characteristics of the intra prediction mode are not considered, excessive smoothing may occur or a soothing effect may not be obtained as needed. However, according to an embodiment of the present disclosure, a generalized weight is used so as to consider the characteristics of the intra prediction mode to prevent such a problem from occurring.

Hereinafter, a method for generating the prediction sample through application of the weight will be described as an example.

FIG. 14 is a diagram illustrating a method for generating a weight-based intra prediction sample according to an embodiment of the present disclosure.

Referring to FIG. 14, it is assumed that the intra prediction mode of the current block is the planner mode and the weighted intra prediction is applied. First, as illustrated in FIGS. 14(a) and 14(b), the encoder/decoder generates a bottom right reference sample of the current block and then interpolates the bottom right reference sample and peripheral reference samples (i.e., an upper right reference sample and a lower left reference sample) of the current block to generate a right reference sample and a lower reference sample. In addition, as illustrated in FIG. 14(c), the encoder/decoder may generate the first prediction sample using the left reference sample and the right reference sample and as illustrated in FIG. 14(d), the encoder/decoder may generate the second prediction sample using an upper reference sample and the lower reference sample. In this case, Equations 4 and/or 5 described above may be used.

In addition, as illustrated in FIG. 14(e), the encoder/decoder weight-adds the first prediction sample and the second prediction sample to generate the final prediction sample. In this case, Equation 6 described above may be used. As described above, when an integer weighted value is used for integer computation, the encoder/decoder normalizes a value acquired by weight-adding the first prediction sample and the second prediction sample to generate the final prediction sample as illustrated in FIG. 14(e). In this case, Equation 7 described above may be used. Further, WeightA represents a weight of each pixel location in the weight table described in FIG. 12 or 13 above and WeightB represents a weight derived to a (normalization—WeightA) by considering the normalization.

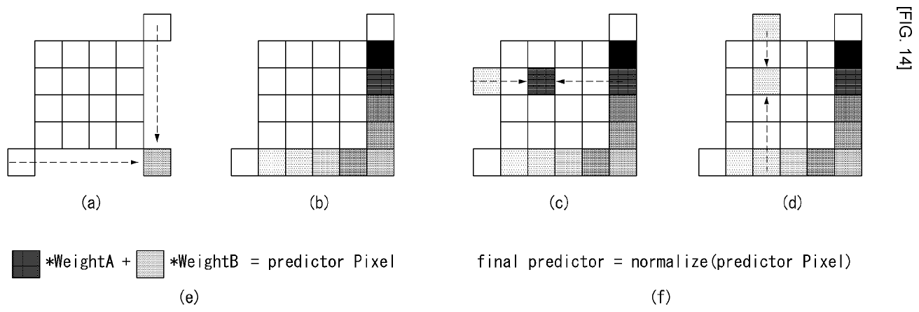

FIG. 15 is a diagram illustrating a method for generating a weight-based intra prediction sample according to an embodiment of the present disclosure.

Referring to FIG. 15, it is assumed that the intra prediction mode of the current block is a diagonal mode (for example, prediction mode #2 of FIG. 6 described above) and the weighted intra prediction is applied.

The encoder/decoder may determine bi-directional reference samples (i.e., the first and second prediction samples) used for generating the prediction sample of each pixel in the current block based on the prediction direction of the current prediction mode as illustrated in FIGS. 15(a) and 15(b). In addition, as illustrated in FIG. 15(c), the encoder/decoder weight-adds the first prediction sample and the second prediction sample to generate the final prediction sample. When the integer weighted value is used, the encoder/decoder normalizes the value acquired by weight-adding the first prediction sample and the second prediction sample to generate the final prediction sample as illustrated in FIG. 14(d).

[symbol]

### EMBODIMENT 4

In an embodiment of the present disclosure, the encoder/decoder may use additional information in order to determine whether to generate the prediction block (or enhanced prediction block) by a prediction method for limitedly applying the weight to the reference sample or the prediction sample in the specific prediction mode. As an example, the encoder may select a more appropriate intra prediction method by transmitting an on/off flag to the decoder as the additional information.

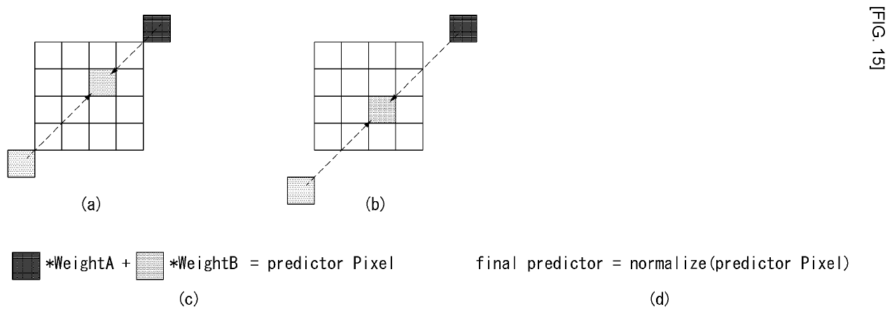

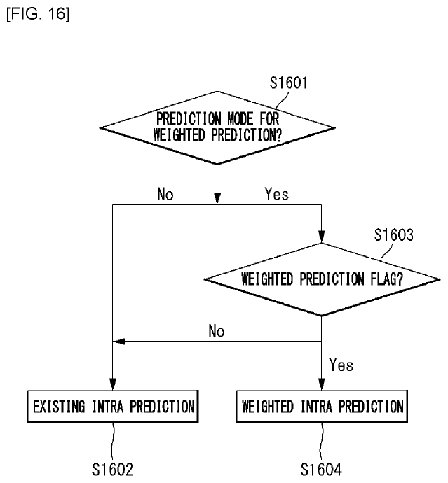

FIG. 16 is a flowchart showing a method for determining whether to apply weight intra prediction based on an intra prediction mode as an embodiment to which the present disclosure is applied.

Referring to FIG. 16, the method is described mainly for the decoder for convenience of description, but the weighted intra prediction method proposed by the present disclosure may be equally performed even in the encoder.

The decoder checks whether the prediction mode applied to the intra prediction of the current block is a prediction mode for weighted prediction (S1601). For example, the decoder may apply the weight-based prediction method only to a specific intra prediction mode and apply the general intra prediction method to the remaining prediction modes.

When the intra prediction mode of the current block is not the prediction mode for the weighted intra prediction, the decoder generates the intra prediction block by applying the general intra prediction method (S1602). In this case, the methods described in FIGS. 5 and 6 above may be applied.

When the intra prediction mode of the current block is the prediction mode for the weighted intra prediction, the decoder checks (or parses) a weighted prediction flag indicating whether the weighted intra prediction is applied to the current block (S1603).

According to a result of checking in step S1603, when the weighed intra prediction is applied to the current block, the decoder generates the intra prediction block by applying the weight-based intra prediction method (S1604). In this case, the method described in FIG. 7 above may be applied.

[symbol]

### EMBODIMENT 5

In an embodiment of the present disclosure, the encoder/decoder may add the prediction mode of the weighted intra prediction as a separate prediction mode. In Embodiment 2 or 4 above, the method for replacing the existing intra prediction mode is described. Such a method has an advantage of minimizing overhead, but when the prediction mode is narrowly selected according to a Rate-Distortion Optimization (RDO) method of the encoder, a problem that prediction performance may be influenced by a selection probability of the corresponding mode may occur. As such, when the existing intra prediction mode is replaced according to the weighted intra prediction, a prediction performance enhancement effect by the existing intra prediction method may be reduced.

Accordingly, the present disclosure proposes a method for using the weighted intra prediction mode as an additional intra prediction mode in order to solve such a problem. For example, when it is assumed that the weighted intra prediction method is applied to a total of N prediction modes including the planar mode, all prediction mode indexes may be shown in Table 2 below.

TABLE 2

| Existing intra mode index | Intra mode index of present disclosure |
|---|---|
| 0 (DC) | 0 (DC) |
| 1 (Planar) | 1 (Planar) |
| 2 | 2 (Planar-Weight) |
| 3 | 3 |
| . . . | 4 |
| 66 | . . . |
| | 66 + N (N indicates the |
| | number of newly added modes) |

Referring to Table 2, it is assumed that the existing intra prediction mode is constituted by a total of 66 prediction modes including the DC mode (mode #0), the planar mode (mode #1), modes #2, 3, . . . , 66. As an example, the encoder/decoder may add a planar-weighted mode representing the planar mode to which the weighted intra prediction is applied to the existing intra prediction mode. Table 2 is just one example and a plurality of weight-based intra prediction modes may be added as a new prediction mode. Further, a prediction mode order or index shown in Table 2 may be changed, of course.

[symbol]

### EMBODIMENT 6

In an embodiment of the present disclosure, proposed is a method for simplifying a prediction computation by combining a duplicated weight applying process in performing the weighted intra prediction. The encoder/decoder may perform the weighted intra prediction by mixing a method for generating the prediction sample by applying the weight to the reference sample described above and a method for generating the prediction sample by applying the weight to a temporary prediction sample.

FIG. 17 is a diagram illustrating a method for generating a weight-based intra prediction sample as an embodiment to which the present disclosure is applied.

Referring to FIG. 17, it is assumed that the intra prediction mode of the current block is the planner mode and the weighted intra prediction is applied.

First, as illustrated in FIGS. 14(a), 14(b), 14(c), and 14(d), the encoder/decoder generates a bottom right reference sample of the current block and then interpolates the bottom right reference sample and peripheral reference samples (i.e., an upper right reference sample and a lower left reference sample) of the current block to generate a right reference sample and a lower reference sample. In addition, the encoder/decoder may generate the first prediction sample using the left reference sample and the right reference sample and generate the second prediction sample using the upper reference sample and the lower reference sample.

The encoder/decoder may generate an intermediate prediction sample using the existing intra prediction method (i.e., generate the intermediate prediction sample using the left and upper reference samples) as illustrated in FIG. 17(e) and generate the final prediction sample by adding the intermediate prediction sample, the first prediction sample, and the second prediction sample as illustrated in FIG. 17(f).

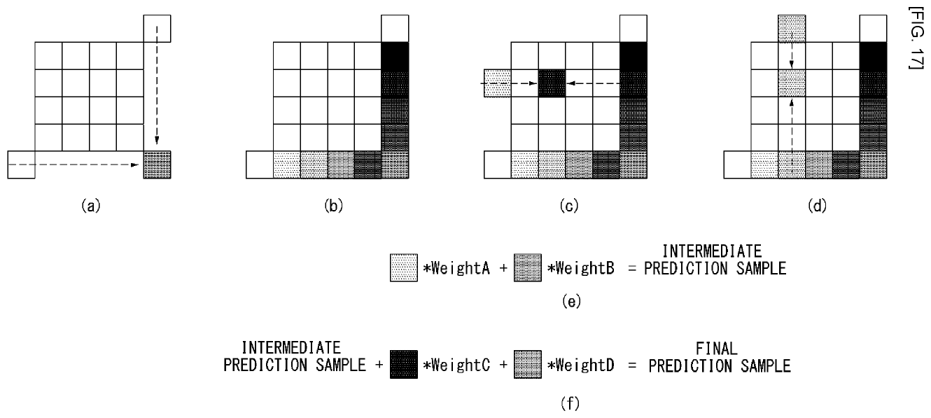

FIG. 18 is a diagram illustrating a method for generating a weight-based intra prediction sample as an embodiment to which the present disclosure is applied.

In the encoder/decoder, steps (e) and (f) of FIG. 17 above may be implemented as a single step as illustrated in FIG. 18.

Specifically, the encoder/decoder generates a bottom right reference sample of the current block and then interpolates the bottom right reference sample and peripheral reference samples (i.e., an upper right reference sample and a lower left reference sample) of the current block to generate a right reference sample and a lower reference sample. In addition, the encoder/decoder may generate the first prediction sample using the left reference sample and the right reference sample and generate the second prediction sample using the upper reference sample and the lower reference sample.

In addition, the encoder/decoder may generate the final prediction sample by weight-adding a total of four reference samples including the first prediction sample, the second prediction sample, a left reference sample adjacent in a horizontal direction, and an upper reference sample adjacent in a vertical direction.

In an embodiment, after the final prediction sample is generated by multiplying each reference sample by the weight, a normalization process therefor may be required. In this case, the normalization may be performed using

Equation 8 below and a normalization value may be determined by an addition of the weights illustrated in FIG. 18.

weighted predictor=normalize(predictor Pixel) [Equation 8]

[symbol]

### EMBODIMENT 7

An embodiment of the present disclosure proposes a combination of the existing intra prediction method and the weighted intra prediction method in the aforementioned embodiments.

The encoder/decoder may apply an additional correction method such as the PDPC described above or Multi Parameter Intra (MPI) to a prediction mode in which effective smoothing is not performed even through the weighted intra prediction method.

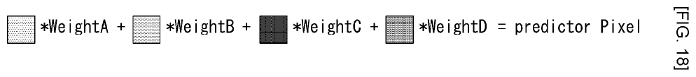

FIG. 19 is a diagram illustrating a method for generating a weight-based intra prediction sample as an embodiment to which the present disclosure is applied.

Referring to FIG. 19, it is assumed that the intra prediction mode of the current block is the planner mode and the weighted intra prediction is applied.

First, by the same method as described in FIGS. 14(a), 14(b), 14(c), and 14(d) above, the encoder/decoder generates the bottom right reference sample of the current block and then interpolates the bottom right reference sample and peripheral reference samples (i.e., the upper right reference sample and the lower left reference sample) of the current block to generate the right reference sample and the lower reference sample. In addition, the encoder/decoder may generate the first prediction sample using the left reference sample and the right reference sample and generate the second prediction sample using the upper reference sample and the lower reference sample. In addition, the encoder/decoder weight-adds the first prediction sample and the second prediction sample to generate the intermediate prediction sample.

Thereafter, the encoder/decoder may generate the final prediction sample using the intermediate prediction sample and the peripheral reference samples. Specifically, the encoder/decoder may generate the final prediction sample by weight-adding the intermediate prediction sample, the left reference sample adjacent in the horizontal direction, the upper reference sample adjacent in the vertical direction, and the top left reference sample.

In an embodiment, the encoder/decoder may perform prediction by referring to a reference sample (e.g., PDPC) filtered using the low pass filter. In other words, the encoder/decoder may generate the intermediate prediction sample using filtered reference samples and then generate the final prediction sample through weight-addition of reference samples (the left reference sample adjacent in the horizontal direction, the upper reference sample adjacent in the vertical direction, and the top left reference sample) which are not filtered.

[symbol]

In respect to the embodiments described above, respective embodiments may be independent and be individually performed or one or more some embodiments may be combined and performed.

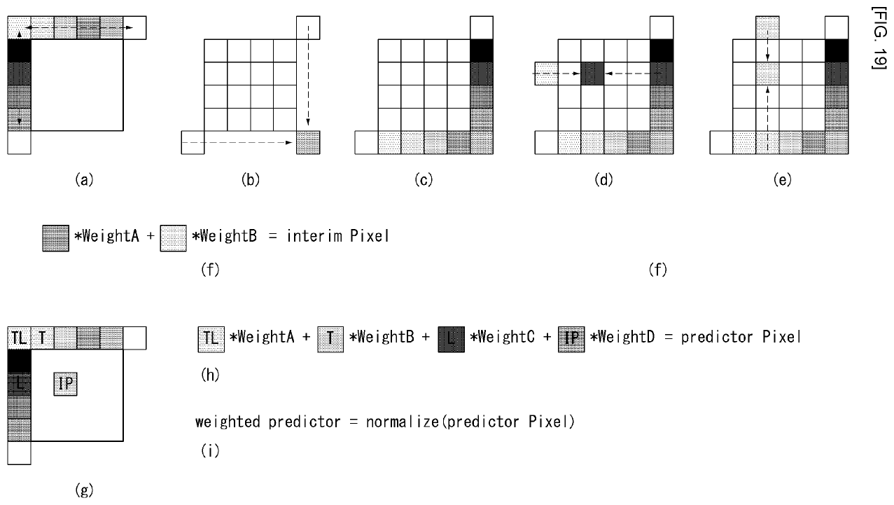

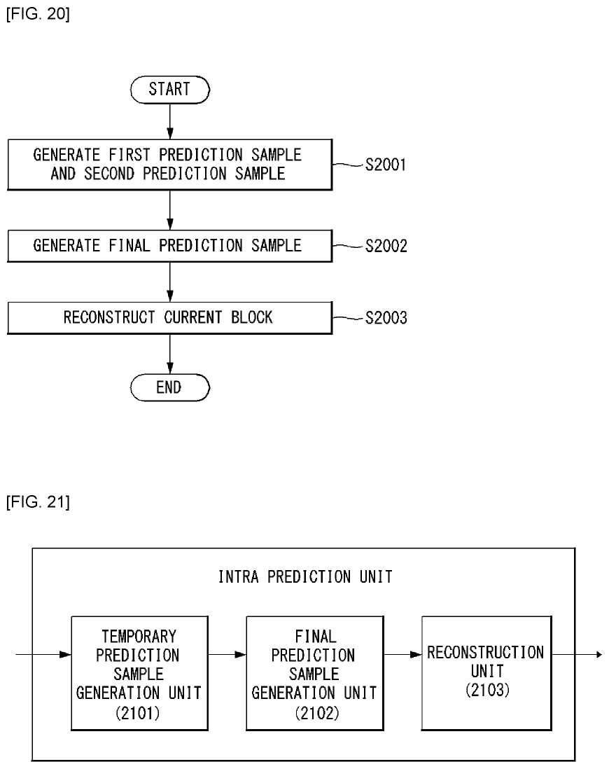

FIG. 20 is a diagram illustrating an intra prediction mode image processing method according to an embodiment of the present disclosure.

Referring to FIG. 20, the method is described based on the decoder for convenience of description, but the method proposed by the present disclosure may be equally applied even in the encoder.

The decoder generates a first prediction sample and a second prediction sample using a reference sample adjacent to a current block (S2001).

The method proposed by the present disclosure may be applied to PDPC, linear interpolation intra prediction (LIP), bi-linear interpolation intra prediction, or multi reference sample line intra prediction.

As an example, the first prediction sample may be generated by using a reference sample determined according to a prediction direction of a prediction mode of the current block among reference samples which are not filtered and the second prediction sample may be generated by using a reference sample determined according to the prediction direction of the prediction mode of the current block among filtered reference samples. In this case, reference sample filtering may be performed by the decoder.

As another example, when the linear interpolation intra prediction or the bi-linear interpolation intra prediction is applied, the decoder may derive a bottom right reference sample adjacent to a lower right side of the current block and derive lower and right reference samples of the current block using a left reference sample, an upper reference sample, and the bottom right reference sample of the current block. In this case, the first prediction sample may be generated by using a reference sample determined according to a prediction direction of a prediction mode of the current block among the left or upper reference samples and the second prediction sample may be generated by using a reference sample determined according to the prediction direction of the prediction mode of the current block among the lower or right reference samples.

Further, as described in Embodiment 2 above, when the prediction mode of the current block belongs to a predetermined specific prediction mode, weighted intra prediction may be limitedly applied.

The decoder generates a final prediction sample of the current block by weight-adding the first prediction sample and the second prediction sample (S2002).

As described in Embodiment 3 above, weights applied to the first prediction sample and the second prediction sample, respectively may be determined by using a predetermined weight table.

As described above, the weight table may be generated based on a distance from a reference pixel determined according the prediction direction of the specific prediction mode.

Further, as described in Embodiment 5 above, a flag indicating whether to apply a weight intra prediction of generating the prediction sample using reference samples in which weights are applied to the current block may be transmitted from an encoder.

The decoder reconstructs the current block by adding the final prediction sample to a residual sample of the current block (S2003).

FIG. 21 is a diagram more specifically illustrating a decoder according to an embodiment of the present disclosure.

In FIG. 21, the intra prediction unit is illustrated as one block for convenience of description, but the inter prediction unit may be implemented in a configuration included in the encoder and/or the decoder. Further, the reconstruction unit 2103 may be implemented as a separate component apart from the intra prediction unit.

Referring to FIG. 21, the intra prediction unit implements the functions, procedures, and/or methods proposed in FIGS. 7 to 20 above. Specifically, the intra prediction unit may include a temporary prediction sample generation unit 2101, a final prediction sample generation unit 2012, and a reconstruction unit 2103.

The temporary prediction sample generation unit 2101 generates a first prediction sample and a second prediction sample using a reference sample adjacent to a current block.

The method proposed by the present disclosure may be applied to PDPC, linear interpolation intra prediction (LIP), bi-linear interpolation intra prediction, or multi reference sample line intra prediction.

As an example, the first prediction sample may be generated by using a reference sample determined according to a prediction direction of a prediction mode of the current block among reference samples which are not filtered and the second prediction sample may be generated by using a reference sample determined according to the prediction direction of the prediction mode of the current block among filtered reference samples. In this case, reference sample filtering may be performed by the decoder.

As another example, when the linear interpolation intra prediction or the bi-linear interpolation intra prediction is applied, the decoder may derive a bottom right reference sample adjacent to a lower right side of the current block and derive lower and right reference samples of the current block using a left reference sample, an upper reference sample, and the bottom right reference sample of the current block. In this case, the first prediction sample may be generated by using a reference sample determined according to a prediction direction of a prediction mode of the current block among the left or upper reference samples and the second prediction sample may be generated by using a reference sample determined according to the prediction direction of the prediction mode of the current block among the lower or right reference samples.

Further, as described in Embodiment 2 above, when the prediction mode of the current block belongs to a predetermined specific prediction mode, weighted intra prediction may be limitedly applied.

The final prediction sample generation unit 2102 generates the final prediction sample of the current block by weight-adding the first prediction sample and the second prediction sample.

As described in Embodiment 3 above, weights applied to the first prediction sample and the second prediction sample, respectively may be determined by using a predetermined weight table.

As described above, the weight table may be generated based on a distance from a reference pixel determined according the prediction direction of the specific prediction mode.

Further, as described in Embodiment 5 above, a flag indicating whether to apply a weight intra prediction of generating the prediction sample using reference samples in which weights are applied to the current block may be transmitted from an encoder.

The reconstruction unit 2103 reconstructs the current block by adding the final prediction sample to a residual sample of the current block.

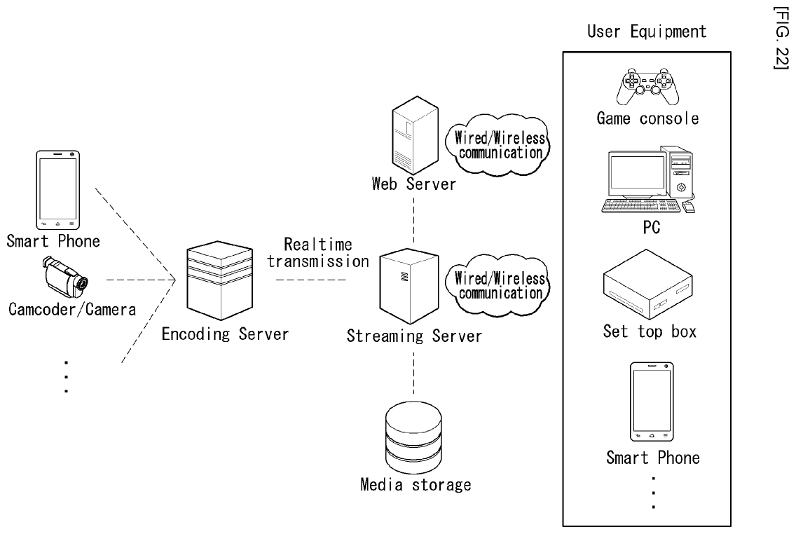

FIG. 22 is a structure diagram of a content streaming system as an embodiment to which the present disclosure is applied.

Referring to FIG. 22, the content streaming system to which the present disclosure is applied may largely include an encoding server, a streaming server, a web server, a media storage, a user device, and a multimedia input device.

The encoding server compresses contents input from multimedia input devices including a smartphone, a camera, a camcorder, etc., into digital data to serve to generate the bitstream and transmit the bitstream to the streaming server. As another example, when the multimedia input devices including the smartphone, the camera, the camcorder, etc., directly generate the bitstream, the encoding server may be omitted.

The bitstream may be generated by the encoding method or the bitstream generating method to which the present disclosure is applied and the streaming server may temporarily store the bitstream in the process of transmitting or receiving the bitstream.

The streaming server transmits multimedia data to the user device based on a user request through a web server, and the web server serves as an intermediary for informing a user of what service there is. When the user requests a desired service to the web server, the web server transfers the requested service to the streaming server and the streaming server transmits the multimedia data to the user. In this case, the content streaming system may include a separate control server and in this case, the control server serves to control a command/response between respective devices in the content streaming system.

The streaming server may receive contents from the media storage and/or the encoding server. For example, when the streaming server receives the contents from the encoding server, the streaming server may receive the contents in real time. In this case, the streaming server may store the bitstream fora predetermined time in order to provide a smooth streaming service.

Examples of the user device may include a cellular phone, a smart phone, a laptop computer, a digital broadcasting terminal, a personal digital assistants (PDA), a portable multimedia player (PMP), a navigation, a slate PC, a tablet PC, an ultrabook, a wearable device such as a smartwatch, a smart glass, or a head mounted display (HMD), etc., and the like.

Each server in the content streaming system may be operated as a distributed server and in this case, data received by each server may be distributed and processed.

[symbol]

As described above, the embodiments described in the present disclosure may be implemented and performed on a processor, a microprocessor, a controller, or a chip. For example, functional units illustrated in each drawing may be implemented and performed on a computer, the processor, the microprocessor, the controller, or the chip.

In addition, the decoder and the encoder to which the present disclosure may be included in a multimedia broadcasting transmitting and receiving device, a mobile communication terminal, a home cinema video device, a digital cinema video device, a surveillance camera, a video chat device, a real time communication device such as video communication, a mobile streaming device, storage media, a camcorder, a video on demand (VoD) service providing device, an (Over the top) OTT video device, an Internet streaming service providing devices, a 3 dimensional (3D) video device, a video telephone video device, a transportation means terminal (e.g., a vehicle terminal, an airplane terminal, a ship terminal, etc.), and a medical video device, etc., and may be used to process a video signal or a data signal. For example, the Over the top (OTT) video device may include a game console, a Blu-ray player, an Internet access TV, a home theater system, a smartphone, a tablet PC, a digital video recorder (DVR), and the like.

In addition, a processing method to which the present disclosure is applied may be produced in the form of a program executed by the computer, and may be stored in a computer-readable recording medium. Multimedia data having a data structure according to the present disclosure may also be stored in the computer-readable recording medium. The computer-readable recording medium includes all types of storage devices and distribution storage devices storing computer-readable data. The computer-readable recording medium may include, for example, a Blu-ray disc (BD), a universal serial bus (USB), a ROM, a PROM, an EPROM, an EEPROM, a RAM, a CD-ROM, a magnetic tape, a floppy disk, and an optical data storage device. Further, the computer-readable recording medium includes media implemented in the form of a carrier wave (e.g., transmission over the Internet). Further, the bitstream generated by the encoding method may be stored in the computer-readable recording medium or transmitted through a wired/wireless communication network.

In addition, the embodiment of the present disclosure may be implemented as a computer program product by a program code, which may be performed on the computer by the embodiment of the present disclosure. The program code may be stored on a computer-readable carrier.

In the embodiments described above, the components and the features of the present disclosure are combined in a predetermined form. Each component or feature should be considered as an option unless otherwise expressly stated. Each component or feature may be implemented not to be associated with other components or features. Further, the embodiment of the present disclosure may be configured by associating some components and/or features. The order of the operations described in the embodiments of the present disclosure may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present disclosure may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices

(PLDs), field programmable gate arrays (FPGAs), processors, controllers, micro-controllers, microprocessors, TVs, set-top boxes, computers, PCs, cellular phones, smart phones, and the like.

In the case of implementation by firmware or software, the embodiment of the present disclosure may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present disclosure may be embodied in other specific forms without departing from essential characteristics of the present disclosure. Accordingly, the aforementioned detailed description should not be construed as restrictive in all terms and should be exemplarily considered. The scope of the present disclosure should be determined by rational construing of the appended claims and all modifications within an equivalent scope of the present disclosure are included in the scope of the present disclosure.

### INDUSTRIAL APPLICABILITY

Hereinabove, the preferred embodiments of the present disclosure are disclosed for an illustrative purpose and hereinafter, modifications, changes, substitutions, or additions of various other embodiments will be made within the technical spirit and the technical scope of the present disclosure disclosed in the appended claims by those skilled in the art.

1. A method for processing an image based on an intra prediction mode, the method comprising:
generating a first prediction sample and a second prediction sample using a reference sample adjacent to a current block;
generating a final prediction sample of the current block by performing a weighted addition of the first and second prediction samples; and
reconstructing the current block by adding the final prediction sample to a residual sample of the current block.

2. The method of claim 1, wherein the generating of the first and second prediction samples includes filtering the reference sample adjacent to the current block, and
wherein the first prediction sample is generated by using a reference sample determined according to a prediction direction of a prediction mode of the current block among reference samples which are not filtered and the second prediction sample is generated by using a reference sample determined according to the prediction direction of the prediction mode of the current block among filtered reference samples.

3. The method of claim 1, wherein the generating of the first and second prediction samples includes
deriving a bottom right reference sample adjacent to a lower right side of the current block, and
deriving lower and right reference samples of the current block using a left reference sample, an upper reference sample, and the bottom right reference sample of the current block, and
wherein the first prediction sample is generated by using a reference sample determined according to the prediction direction of the prediction mode of the current block among the left or upper reference samples, and
wherein the second prediction sample is generated by using a reference sample determined according to the prediction direction of the prediction mode of the current block among the lower or right reference samples.

4. The method of claim 1, wherein when the prediction mode of the current block belongs to a predetermined specific prediction mode, a weight intra prediction of generating a prediction sample using reference samples in which a weight is applied to the current block is applied.

5. The method of claim 1, wherein weights applied to the first prediction sample and the second prediction sample, respectively are determined by using a predetermined weight table.

6. The method of claim 5, wherein the weight table is generated based on a distance from a reference pixel determined according a prediction direction of a specific prediction mode.

7. The method of claim 1, wherein a flag indicating whether to apply a weight intra prediction of generating the prediction sample using reference samples in which weights are applied to the current block is transmitted from an encoder.

8. An apparatus for processing an image based on an intra prediction mode, the apparatus comprising:
a temporary prediction sample generation unit generating a first prediction sample and a second prediction sample using a reference sample adjacent to a current block;
a final prediction sample generation unit generating a final prediction sample of the current block by performing a weighted addition of the first and second prediction samples; and
a reconstruction unit reconstructing the current block by adding the final prediction sample to a residual sample of the current block.

9. The apparatus of claim 8, wherein the temporary prediction sample generation unit filters the reference sample adjacent to the current block, and wherein the first prediction sample is generated by using a reference sample determined according to the prediction direction of the prediction mode of the current block among reference samples which are not filtered, and
wherein the second prediction sample is generated by using a reference sample determined according to the prediction direction of the prediction mode of the current block among filtered reference samples.

10. The apparatus of claim 8, wherein the temporary prediction sample generation unit derives a bottom right reference sample adjacent to a lower right side of the current block and derives lower and right reference samples of the current block using a left reference sample, an upper reference sample, and the bottom right reference sample of the current block, and
wherein the first prediction sample is generated by using a reference sample determined according to the prediction direction of the prediction mode of the current block among the left or upper reference samples, and wherein the second prediction sample is generated by using a reference sample determined according to the prediction direction of the prediction mode of the current block among the lower or right reference samples.

11. The apparatus of claim 8, wherein when the prediction mode of the current block belongs to a predetermined specific prediction mode, a weight intra prediction of generating a prediction sample using reference samples in which a weight is applied to the current block is applied.

12. The apparatus of claim 8, wherein weights applied to the first prediction sample and the second prediction sample, respectively are determined by using a predetermined weight table.

13. The apparatus of claim 12, wherein the weight table is generated based on a distance from a reference pixel determined according a prediction direction of a specific prediction mode.

14. The apparatus of claim 8, wherein a flag indicating whether to apply a weight intra prediction of generating the prediction sample using reference samples in which weights are applied to the current block is transmitted from an encoder.
